(19) United States
(12) Patent Application Publication
(10) Pub. No.: US 2015/0284257 A1
(43) Pub. Date: Oct. 8, 2015

(54) METHOD FOR PRODUCING TITANIUM OXIDE PARTICLES, TITANIUM OXIDE PARTICLES, AND INK COMPOSITION CONTAINING TITANIUM OXIDE PARTICLES

(71) Applicant: CANON KABUSHIKI KAISHA, Tokyo (JP)

(72) Inventors: Yoshinori Kotani, Yokohama-shi (JP); Motokazu Kobayashi, Yokohama-shi (JP)

(21) Appl. No.: 14/677,677

(22) Filed: Apr. 2, 2015

(30) Foreign Application Priority Data
Apr. 4, 2014 (JP) 2014-077897

(51) Int. Cl. C01G 23/053; C08K 3/22; C09D 11/322

(52) U.S. Cl. CPC C01G 23/053; C09D 11/322; C08K 3/22; C08K 2003/2237; C01P 2006/16; C01P 2006/12

(57) ABSTRACT

A method for producing titanium oxide particles through hydrolysis and polycondensation of compound A including at least one member selected from the groups consisting of titanium alkoxides and titanium chlorides includes the step of hydrolyzing the compound A in the presence of a basic catalyst, water, and compound B capable of suppressing hydrolysis or polycondensation of at least one of the members of the compound A.

### BACKGROUND OF THE INVENTION

1. Field of the Invention

The present application relates to a method for producing titanium oxide particles.

2. Description of the Related Art

Particulate titanium oxide, or titanium oxide particles, which is used as a white pigment in ink jet recording ink or the like, has a high refractive index and is superior in white color developability. Japanese Patent Laid-Open No. 2009-1472 discloses a method for producing such particulate titanium oxide, or titanium oxide particles.

In general, titanium oxide particles having larger particle sizes exhibit higher hiding power. Larger particles of, for example, titanium oxide however tend to settle when dispersed in fluid, such as liquid.

### SUMMARY OF THE INVENTION

Accordingly, the present application provides a method for producing titanium oxide particles through hydrolysis and polycondensation of compound A including at least one member selected from the groups consisting of titanium alkoxides and titanium chlorides. The method includes the step of hydrolyzing the compound A in the presence of a basic catalyst, water, and compound B capable of suppressing hydrolysis or polycondensation of at least one of the members of the compound A.

Further features of the present invention will become apparent from the following description of exemplary embodiments with reference to the attached drawings.

### BRIEF DESCRIPTION OF THE DRAWINGS

FIG. 1 is an SEM photograph of the surface of a porous titanium oxide particle produced in Example 1.

FIG. 2 is an SEM photograph of the surface of a titanium oxide particle produced in Comparative Example 1.

FIG. 3 is a flow chart illustrating a method for producing porous titanium oxide particles according to an embodiment of the present application.

FIG. 4 is an SEM photograph of the surface of a porous titanium oxide particle produced in Example 4.

FIG. 5 is an SEM photograph of the surface of a porous titanium oxide particle produced in Example 5.

### DESCRIPTION OF THE EMBODIMENTS

### Premise

In general, for calculating the sedimentation velocity V (cm/s) of particles dispersed in a dispersion medium (fluid), Stokes' law expressed by the following equation (1) is used.

$$V = \frac{g ( {ρ}_{s} - ρ ) {d}^{2}}{18 μ} \qquad ( 1 )$$

In equation (1), g represents gravitational acceleration (980.7 cm/s²), ρₛ represents the density (g/cm³) of a particle, and ρ represents the density (g/cm³) of the dispersion medium. d Represents the diameter of the particle (cm) and μ represents the viscosity (g/cm·s) of the dispersion medium.

Equation (1) shows that the sedimentation velocity V of particles is proportional to the difference between the density ρₛ of the particles and the density ρ of the dispersion medium and to the square of the diameter d of the particles, and is inversely proportional to the viscosity μ of the dispersion medium.

Accordingly, for reducing the sedimentation velocity V of particles while keeping the diameter d of the particles to some extent, two approaches are possible: reducing the difference between the density ρₛ of the particles and the density ρ of the dispersion medium; and increasing the viscosity μ of the dispersion medium.

For an aqueous ink jet ink, however, the viscosity of the aqueous dispersion medium cannot be varied much in view of the features of the ink jet method. It is also difficult to vary the density of the dispersion medium. Accordingly, it is effective in reducing the sedimentation velocity of particles to reduce the density of the particles. The present inventors thought of an approach to achieving this of making particles porous.

In equation (1), the density ρₛ of particles represents the apparent density of the particles. More specifically, the density ρₛ of a porous particle is calculated using the volume of the particle includes the volume of the solid portion of the particle and the volume of pores and voids in the particle. When a particle is made porous, the apparent density of the particle decreases. When a particle has a porosity of A, the apparent density of the particle is (1−A) times the true density of the particle. The sedimentation velocity V of equation (1) is thus reduced. The term “relative density” used herein refers to the ratio (ρₛ/ρ) of the density of the particle to the density of the dispersion medium. The apparent density of a particle can be measured using a fluid such as mercury that does not wet the surfaces of particles.

### Embodiment

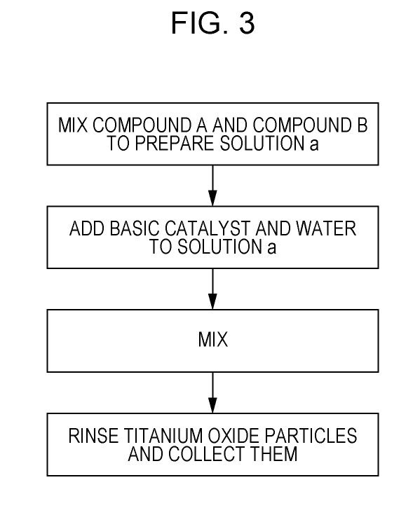

A method for producing titanium oxide particles according to an embodiment will now be described with reference to FIG. 3. FIG. 3 is a flow chart illustrating the method for producing titanium oxide particles of the embodiment.

This method produces titanium oxide particles through hydrolysis and polycondensation of Compound A including at least one member selected from the group consisting of titanium alkoxides and titanium chlorides, and includes the step of hydrolyzing Compound A in the presence of a basic catalyst, water, and Compound B capable of suppressing the hydrolysis or polycondensation of at least one member of Compound A.

Compound A is selected from the group consisting of titanium alkoxides and titanium chlorides, and from which titanium oxide particles are formed by hydrolysis and polycondensation (sol-gel reaction). Compound A may be a single compound or a combination of two or more compounds.

Compound B can suppress the hydrolysis or polycondensation of at least one member of Compound A. Compound B, which may suppress the hydrolysis of at least one member of Compound A or may suppress the polycondensation thereof, typically suppresses hydrolysis of at least one member of Compound A, thereby suppressing the polycondensation thereof. If Compound A includes a plurality of member compounds, Compound B may suppress the hydrolysis or polycondensation of one member of Compound A. Alternatively, Compound B may suppress the hydrolysis or polycondensation of some or all members of Compound A.

When a molecule of compound B coordinates to the titanium atom of the molecule of a titanium alkoxide or titanium chloride to form a titanium oxide precursor that causes hydrolysis and polycondensation reactions, the reactions can be expressed by the following formulas (2) to (4):

TiX₄+L→TiX₃L+X (2)

TiX₃L+H₂O→TiX₂L(OH)+XH (3)

2TiX₂L(OH)→TiOTiX₄L₂+H₂O (4)

In formulas (2) to (4), X represents an alkoxyl group or a chlorine atom, and L represents compound B.

Compound A may be a titanium alkoxide, a titanium chloride, or a combination of a titanium alkoxide and a titanium chloride. From the viewpoint of stability, a titanium alkoxide is advantageous.

Examples of the titanium alkoxide include, but are not limited to, tetramethoxy titanium, tetraethoxy titanium, tetra-n-propoxy titanium, tetraisopropoxy titanium, tetra-n-butoxy titanium, and tetraisobutoxy titanium.

Examples of the titanium chloride include, but are not limited to, titanium tetrachloride.

Probably, Compound B suppresses the hydrolysis or polycondensation of at least one member of Compound A, that is at least one of titanium alkoxides and titanium chlorides, through the following mechanism.

Titanium alkoxides and titanium chlorides are reactive with water and are hence hydrolyzable. If a titanium alkoxide or a titanium chloride is mixed with water, accordingly, the titanium alkoxide or titanium chloride is rapidly hydrolyzed to form primary particles having highly reaction-active surfaces. Since the surfaces of the primary particles have high reaction activity, the particles intertwine each other to form a higher-order network structure, thus forming high-density secondary particles.

If Compound B is mixed with at least one member of Compound A, that is, at least one of titanium alkoxides and titanium chlorides, the molecule of Compound B coordinates to the center metal, or the titanium atom, of the titanium alkoxide or titanium chloride, as mentioned above. Consequently, the number of the hydrolyzable reaction sites the titanium atom has decreases, so that polycondensation is suppressed. Thus, the number of the reaction sites at the surfaces of the primary particles (more specifically, the number of hydroxy groups produced by hydrolysis) decreases, and intertwinement of the primary particles is suppressed. Consequently, secondary particles formed by polycondensation or the like of the primary particles do not intertwine much and are thus porous, having many voids.

Examples of such Compound B include β-keto ester compounds, β-diketone compounds, amine compounds, and glycol compounds. Among these compounds, β-keto ester compounds and β-diketone compounds are advantageous. This is probably because these compounds have high performance of coordination to the group or atom of the titanium alkoxide or titanium chloride to be hydrolyzed.

Note that, for example, “X compounds” mentioned herein refers to X and derivatives of X.

Examples of the β-keto ester compounds include methyl acetoacetate, ethyl acetoacetate, allyl acetoacetate, benzyl acetoacetate, isopropyl acetoacetate, tert-butyl acetoacetate, isobutyl acetoacetate, and 2-methoxyethyl acetoacetate.

Examples of the β-diketone compounds include acetylacetone, 3-methyl-2,4-pentanedione, 3-ethyl-2,4-pentanedione, trifluoroacetylacetone, hexafluoroacetylacetone, benzoylacetone, and dibenzoylmethane.

Compound B may be a single compound or a combination of a plurality of compounds.

Compound B is desirably used in a proportion in the range of 0.3 mole to 1.0 mole relative to 1 mole of Compound A. This is because Compound B used in a proportion of 0.3 mole or more can suppress the hydrolysis or polycondensation of Compound A effectively, and Compound B in a proportion of 1.0 mole or less facilitates the formation of particles. If Compound A includes a titanium alkoxide and a titanium chloride, the proportion of Compound B is desirably in the above range relative to the total amount by mole of the titanium alkoxide and the titanium chloride.

The hydrolysis of at least one member of Compound A may be performed in an organic solvent. Examples of such an organic solvent include alcohols, such as methanol, ethanol, 2-propanol, butanol, and ethylene glycol; aliphatic and alicyclic hydrocarbons, such as n-hexane, n-octane, cyclohexane, cyclopentane, and cyclooctane; aromatic hydrocarbons, such as toluene, xylene, and ethylbenzene; esters, such as ethyl formate, ethyl acetate, n-butyl acetate, ethylene glycol monomethyl ether acetate, ethylene glycol monoethyl ether acetate, and ethylene glycol monobutyl ether acetate; ketones, such as acetone, methyl ethyl ketone, methyl isobutyl ketone, and cyclohexanone; ethers, such as dimethoxyethane, tetrahydrofuran, dioxane, and diisopropyl ether; chlorinated hydrocarbons, such as chloroform, methylene chloride, carbon tetrachloride, and tetrachloroethane; and aprotic polar solvents, such as N-methylpyrrolidone, dimethylformamide, dimethylacetamide, and ethylene carbonate. Among these, alcohols are advantageous from the viewpoint of environmental stability.

The solvent is desirably used in a proportion in the range of 10 moles to 200 moles relative to 1 mole of the member of Compound A to be hydrolyzed in the solvent. When the solvent is used in a proportion of 10 moles or more, the resulting titanium oxide particles are unlikely to aggregate; when it is used in a proportion of 200 moles or less, the member of Compound A is easily hydrolyzed and polycondensed.

For hydrolyzing at least one member of Compound A in an organic solvent, Compound A, Compound B, the organic solvent, water, and a catalyst may be mixed in any order without particular limitation. It is however advantageous to prepare Solution (a) containing Compound A, the organic solvent and Compound B and then add a basic catalyst and water to Solution (a). By mixing Compound A and Compound B in the organic solvent in advance, Compound B can be uniformly coordinated to Compound A. By adding then water and the catalyst to Solvent a, Compound A is uniformly hydrolyzed. As an alternative to Solvent a, Solvent b may be used which is a mixture of Compound A, the organic solvent, Compound B and a small amount of water. In this instance, the water in Solution b is desirably in such an amount as Compound A does not hydrolyze.

When the basic catalyst and water are added to Solvent a, the basic catalyst may be first added to Solvent a and then water is added; water may be first added to Solvent a and then the basis catalyst is added; or a solution containing the basic catalyst and water may be added to Solution (a). Advantageously, a solution containing the basic catalyst and water is added to Solution (a). The addition of the basic catalyst and water in this manner allows Compound A to hydrolyze more uniformly, thus helping form titanium oxide particles having a more uniform particle size and specific surface area.

When the basic catalyst and water are added to Solvent a, an alcohol may be added together. The presence of an alcohol helps form porous titanium oxide particles have a uniform particle size.

The alcohol may be a lower alcohol or a higher alcohol. Examples of the alcohol include methanol, ethanol, 1-propanol, 2-propanol, 1-butanol, 2-butanol, 4-methyl-2-pentanol, and 2-ethylbutanol.

For adding the alcohol, a mixture of water and the alcohol may be added to Solution (a) after the basis catalyst is added to Solution (a). Alternatively, the basic catalyst, water and the alcohol may be added to Solution (a) in order of: basic catalyst, water and alcohol; basic catalyst, alcohol and water; water, alcohol and basic alcohol; water, basic catalyst and alcohol; alcohol, water and basic catalyst; or alcohol, basic catalyst and water.

The basis catalyst accelerates the hydrolysis of Compound A. As an alternative to the basic catalyst, an acid catalyst may be used. In the case of using an acid catalyst, the electrophilic reaction of the acid catalyst causes hydrolysis of Compound A. As hydrolysis starts, polycondensation also starts, thus proceeding successively. If the polycondensation reaction proceeds in the presence of an acid catalyst, molecules of Compound A are linearly polycondensed. Examples of the acid catalyst include, but are not limited to, hydrochloric acid and acetic acid.

On the other hand, in the case of using a basic catalyst, the nucleophilic reaction of the basic catalyst causes hydrolysis of Compound A. At this time, the basic catalyst attempts to act directly on the center metal, or the titanium atom, of Compound A, steric hindrance suppress the reaction. The reaction however proceeds stochastically, and the steric hindrance is reduced at OH groups produced by the reaction. Once the reaction starts, most of the reaction sites the titanium atom has are thus substituted with the OH group. In the case of the basic catalyst as well, as hydrolysis starts, polycondensation also starts. In this instance, however, the polycondensation starts after most of the reaction sites have been substituted with the OH group, proceeding so as to form a three-dimensional network structure.

Thus, approximately spherical particles can be formed in the presence of a basic catalyst. This is the reason why the use of a basic catalyst is advantageous.

Examples of the basic catalyst include, but are not limited to, ammonia.

If a solution containing a basic catalyst and water is added to Solution (a), the pH of the solution containing the basic catalyst and water is desirably 8 to 14. If a basic catalyst and water are separately added to Solution (a), the basis catalyst and water are adjusted so that the assumed mixture of the basic catalyst and water could have a pH of 8 to 14.

The total amount by mole of the basic catalyst and water to be added Solution (a) is desirably in the range of 2 moles to 6 moles relative to 1 mole of Compound A in Solution (a).

The porous titanium oxide particles are produced through the above process. The porous titanium oxide particles described herein are defined as titanium oxide particles having pores of 10 nm or more in pore size measured through a scanning electron microscope (SEM) in the surfaces thereof. Desirably, the porous titanium oxide particles have a large number of meso pores having a pore size in the range of 10 nm to 100 nm. The average particle size of the porous titanium oxide particles is desirably in the range of 50 nm to 1 μm. Porous titanium oxide particles having particle size in this range are likely to have high whiteness.

Particles having many pores in the surfaces thereof tend to have large specific surface areas. Accordingly, how many pores are formed in a particle can be estimated by the specific surface area of the particle, and a particle having a larger specific surface area is considered to be more porous. The lower relative density of a more porous particle hampers the settling of the particle. From the viewpoint of hampering the settling of particles effectively, the titanium oxide particles of the present embodiment desirably have a specific surface area of 260 m²/g or more. The specific surface area of the titanium oxide particles may be the BET specific surface area measured by the BET method using an adsorption isotherm prepared through measurements of adsorption of gas such as nitrogen.

The porous titanium oxide particles produced through the above process may be settled in a centrifuge, and the sediment of the particles is rinsed in a solvent and collected. Thus highly pure porous titanium oxide particles are produced.

The resulting porous titanium oxide particles may be used in an ink composition by being dispersed in an aqueous solvent. The aqueous solution may be water or a mixture of water and a water-soluble organic solvent. An alcohol may be used as the water-soluble organic solvent. The ink composition may further contain a lubricant, a dispersant, a surfactant and the like.

### EXAMPLES

The present application will be further described in detail with reference to Examples and Comparative Examples. The application is not however limited to the examples.

In the Examples and Comparative Examples, the surfaces of the porous titanium oxide particles were observed through a scanning electron microscope (FESEM S-4800, manufactured by Hitachi) at an accelerating voltage of 5 kv. The resolution of the scanning electron microscope was 1.0 nm (at an accelerating voltage of 15 kV for a working distance of 4 mm) or 2.0 nm (at an accelerating voltage of 1 kV for a working distance of 1.5 mm).

The average particle size of porous titanium oxide particles was determined by measuring the diameters of particles in a scanning electron micrograph. At this time, at least five particles are randomly selected for calculating the average.

The specific surface areas of the porous titanium oxide particles of the Examples and Comparative Examples were measured with an automatic specific surface area and porosimetry analyzer (Tristar 3000, manufactured by Shimadzu). Adsorption/desorption isotherms of particulate samples were prepared by a nitrogen adsorption method, and the BET specific surface area of each sample was thus determined by the BET method.

### Example 1

Compound A and titanium n-butoxide (TBOT) were dissolved in ethanol (EtOH) to yield a solution. To the resulting solution, ethyl acetoacetate (EAcAc), which is a β-keto ester compound, was added as Compound B for suppressing the hydrolysis or polycondensation of the TBOT to yield Solution (a). Solution (a) was stirred at room temperature for about 2 hours. Then, a mixture of ethanol and 1 wt % ammonia solution (NH₃aq.) was added to Solution (a), and the mixture was stirred for about 6 hours, thus preparing a solution containing porous titanium oxide particles. The proportions of the materials in terms of mole were TBOT:EtOH:EAcAc:NH₃aq.=1:100:1:4.5. The porous titanium oxide particles were settled in a centrifuge, and the sediment of the particles was rinsed with ethanol and collected to yield porous titanium oxide particles.

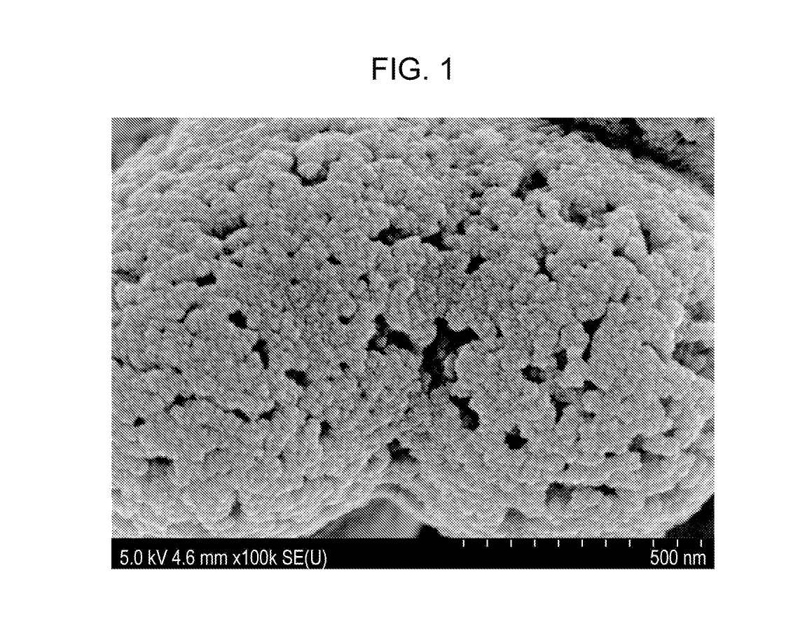

FIG. 1 shows an electron micrograph of the surface of a particle of the resulting porous titanium oxide particles. The average particle size of the porous titanium oxide particles was about 750 nm. It was confirmed that porous titanium oxide particles having a surface structure having many pores of 10 nm to 100 nm in pore size visible through a scanning electron microscope were produced. The BET specific surface area of the resulting porous titanium oxide particles was 261 m²/g.

### Example 2

Porous titanium oxide particles were produced in the same manner as Example 1, except that the proportions of the materials in terms of mole were TBOT:EtOH:EAcAc:NH₃aq.=1:100:1:3. The surfaces of the resulting porous titanium oxide particles were observed in the same manner as in Example 1.

The average particle size of the porous titanium oxide particles was about 1600 nm. It was confirmed as in Example 1 that porous titanium oxide particles having a surface structure having many pores of 10 nm to 100 nm in pore size were produced. The BET specific surface area of the resulting porous titanium oxide particles was 271 m²/g.

### Example 3

Porous titanium oxide particles were produced in the same manner as Example 1, except that the proportions of the materials in terms of mole were TBOT:EtOH:EAcAc:NH₃aq.=1:100:0.7:3. The surfaces of the resulting porous titanium oxide particles were observed in the same manner as in Example 1.

The average particle size of the porous titanium oxide particles was about 500 nm. It was confirmed as in Example 1 that porous titanium oxide particles having a surface structure having many pores of 10 nm to 100 nm in pore size were produced. The BET specific surface area of the resulting porous titanium oxide particles was 281 m²/g.

### Example 4

Porous titanium oxide particles were produced using tert-butyl acetoacetate (t-BuAcAc), which is a β-keto ester compound, as Compound B for suppressing the hydrolysis or polycondensation of TBOT, instead of EAcAc used in Example 1. The porous titanium oxide particles were produced in the same manner as Example 1, except that the proportions of the materials in terms of mole were TBOT:EtOH:t-BuAcAc:NH₃aq.=1:100:1:3. The surfaces of the resulting porous titanium oxide particles were observed in the same manner as in Example 1.

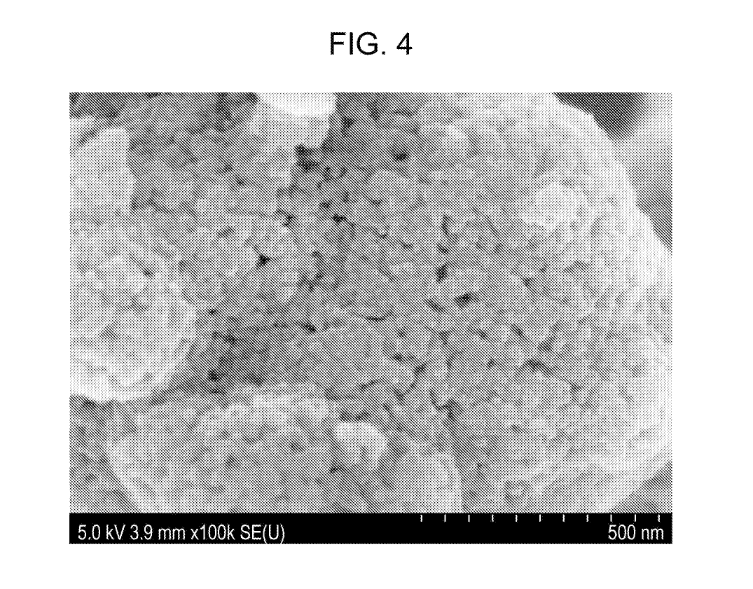

FIG. 4 shows an electron micrograph of the surface of a particle of the resulting porous titanium oxide particles. The average particle size of the porous titanium oxide particles was about 1000 nm. It was confirmed as in Example 1 that porous titanium oxide particles having a surface structure having many pores of 10 nm to 100 nm in pore size were produced. The BET specific surface area of the resulting porous titanium oxide particles was 373 m²/g.

### Example 5

Porous titanium oxide particles were produced using 3-methyl-2,4-pentanedione (MeAcAc), which is a β-diketone compound, as Compound B for suppressing the hydrolysis or polycondensation of TBOT, instead of EAcAc used in Example 1. The porous titanium oxide particles were produced in the same manner as Example 1, except that the proportions of the materials in terms of mole were TBOT:EtOH:MeAcAc:NH₃aq.=1:100:0.3:6. The surfaces of the resulting porous titanium oxide particles were observed in the same manner as in Example 1.

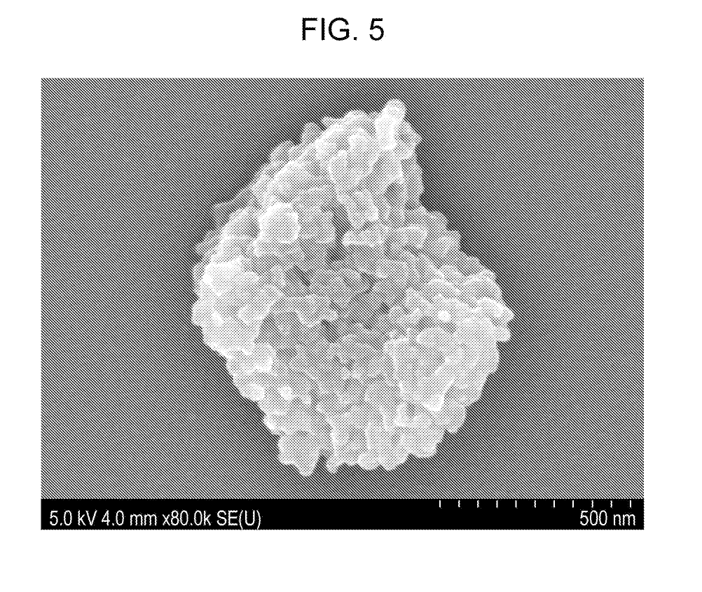

FIG. 5 shows an electron micrograph of the surface of a particle of the resulting porous titanium oxide particles. The average particle size of the resulting porous titanium oxide particles was about 800 nm, and it was confirmed as in Example 1 that porous titanium oxide particles having a surface structure having many pores of 10 nm to 100 nm in pore size were produced. The BET specific surface area of the porous titanium oxide particles was 463 m²/g.

### Example 6

An ink was prepared using the porous titanium oxide particles produced in Example 1. The porous titanium oxide particles were dispersed in water, and an appropriate dispersant and surfactant were added to the dispersion to yield an aqueous ink. The ink was visually white and was thus a white ink composition. The ink was applied to the surface of a colorless, translucent PET film and dried. Thus a white coating film was formed on the PET film. The coating film was visually white, and thus a desired white printed article was produced.

### Comparative Example 1

A mixture of ethanol and 1 wt % ammonia solution (NH₃aq.) was added to a solution prepared by adding TBOT as Compound A to ethanol, and the resulting mixture was stirred for about 6 hours, thus preparing a solution containing titanium oxide particles. The proportions of the materials in terms of mole were TBOT:EtOH:NH₃aq.=1:100:5.

The titanium oxide particles were settled in a centrifuge, and the sediment of the particles was rinsed with ethanol and collected to yield titanium oxide particles.

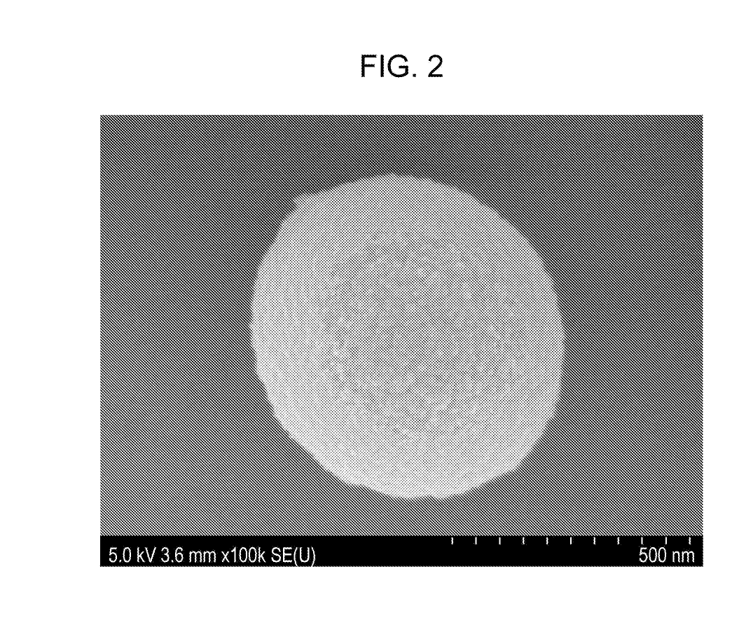

FIG. 2 shows an electron micrograph of the surface of a particle of the resulting titanium oxide particles, observed in the same manner as in Example 1. The average particle size of the resulting titanium oxide particles was about 750 nm, and it was confirmed that titanium oxide particles having a surface structure not having pores of 10 nm to 100 nm in pore size visible through a scanning electron microscope were produced. The BET specific surface area of the titanium oxide particles was 213 m²/g.

### Comparative Example 2

The titanium oxide particles were produced in the same manner as Comparative Example 1, except that the proportions of the materials in terms of mole were TBOT:EtOH:NH₃aq.=1:100:2.5. The surfaces of the resulting titanium oxide particles were observed in the same manner as in Example 1.

The average particle size of the resulting titanium oxide particles was about 1300 nm, and it was confirmed as in Comparative Example 1 that titanium oxide particles having a surface structure not having pores of 10 nm to 100 nm in pore size visible through a scanning electron microscope were produced.

### Comparative Example 3

The titanium oxide particles were produced in the same manner as Comparative Example 1, except that the proportions of the materials in terms of mole were TBOT:EtOH:NH₃aq.=1:100:7.5. The surfaces of the resulting titanium oxide particles were observed in the same manner as in Example 1.

The average particle size of the resulting titanium oxide particles was about 700 nm, and it was confirmed as in Comparative Examples 1 and 2 that titanium oxide particles having a surface structure not having pores of 10 nm to 100 nm in pore size visible through a scanning electron microscope were produced. The BET specific surface area of the titanium oxide particles was 255 m²/g.

The porous titanium oxide particles produced in an embodiment of the application can be used as a white pigment of an ink. In addition, the porous titanium oxide particles may be used as materials for photocatalysts and catalyst carriers and are very functional material.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-077897, filed Apr. 4, 2014, which is hereby incorporated by reference herein in its entirety.

What is claimed is:

1. A method for producing titanium oxide particles through hydrolysis and polycondensation of compound A including at least one member selected from the groups consisting of titanium alkoxides and titanium chlorides, the method comprising:
hydrolyzing the compound A in the presence of a basic catalyst, water, and compound B capable of suppressing hydrolysis or polycondensation of at least one of the members of the compound A.

2. The method according to claim 1, wherein the compound B is at least one compound selected from the group consisting of β-keto ester compounds, β-diketone compounds, amine compounds, and glycol compounds.

3. The method according to claim 1, wherein the compound B is a β-keto ester compound.

4. The method according to claim 1, wherein the compound B is at least one compound selected from the group consisting of ethyl acetoacetate, tert-butyl acetoacetate, and 3-methyl-2,4-pentanedione.

5. The method according to claim 1, wherein the amount by mole of the compound B is in the range of 0.3 mole to 1.0 mole relative to 1 mole of the compound A.

6. The method according to claim 1, wherein the compound A is a titanium alkoxide.

7. The method according to claim 1, wherein the compound A includes a titanium alkoxide and a titanium chloride.

8. The method according to claim 4, wherein the compound A is a titanium n-butoxide.

9. The method according to claim 1, wherein the basic solvent is ammonia.

10. The method according to claim 1, wherein the hydrolyzing of the compound A is performed by adding the basic catalyst and the water to solution (a) containing the compound A, the compound B and a solvent.

11. The method according to claim 1, wherein the hydrolyzing of the compound A is performed by adding the basic catalyst, the water and an alcohol to solution (a) containing the compound A, the compound B and a solvent.

12. The method according to claim 11, wherein the hydrolyzing of the compound A is performed by adding the basic catalyst first to the solution (a), and then adding a mixture of the water and the alcohol to the solution (a).

13. The method according to claim 10, wherein the solvent is an organic solvent.

14. The method according to claim 11, wherein the solvent is an organic solvent.

15. The method according to claim 1, wherein the total amount by mole of the basic catalyst and the water is in the range of 2 moles to 6 moles relative to 1 mole of the compound A.

16. The method according to claim 1, wherein the titanium oxide particle produced by the method has pores having a pore size in the range of 10 nm to 100 nm.

17. An ink composition comprising: titanium oxide particles produced by the method as set forth in claim 1; and an aqueous solvent.

18. A titanium oxide particle having a BET specific surface area of 260 m²/g or more and pores having a pore size in the range of 10 nm to 100 nm.
